(19) United States
(12) Patent Application Publication
(10) Pub. No.: US 2008/0211737 A1
(43) Pub. Date: Sep. 4, 2008

(54) Three-dimensional display apparatus using intermediate elemental images

(76) Inventors: Eun-Soo Kim, Seoul (KR); Dong-Choon Hwang, Yeosu-si (KR); Jae-Sung Park, Seoul (KR); Seung-Chool Kim, Seoul (KR); Dong-Hak Shin, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/004,309

(22) Filed: Dec. 19, 2007

Related U.S. Application Data
(63) Continuation of application No. PCT/KR06/00548, filed on Feb. 17, 2006.

(30) Foreign Application Priority Data
Nov. 16, 2005 (KR) 10-2005-0109801

(51) Int. Cl. G09G 5/00

(52) U.S. Cl. 345/6

(57) ABSTRACT

A three-dimensional image display apparatus using an intermediate elemental image is disclosed. In one embodiment, the three-dimensional image display apparatus includes: i) an image input unit, generating a plurality of elemental images extracted from a three-dimensional object, the elemental images have different perspectives, ii) an image processing unit, generating an intermediate elemental image, using parallax information between the elemental images inputted from the image input unit and iii) an image reproduction unit, reproducing a three-dimensional image corresponding to the three-dimensional object, using the elemental image and the intermediate elemental image. With the three-dimensional image display apparatus, and the method thereof, using an intermediate elemental image in accordance with at least one embodiment of the present invention, a high-resolution three-dimensional image can be outputted.

### CROSS-REFERENCE TO RELATED APPLICATION

This application is a continuation application, and claims the benefit under 35 U.S.C. §§ 120 and 365 of PCT Application No. PCT/KR2006/000548, filed on Feb. 17, 2006, which is hereby incorporated by reference.

### BACKGROUND OF THE INVENTION

1. Field of the Invention

The present invention relates to a three-dimensional display apparatus and a method thereof, more specifically to a three-dimensional display apparatus and a method thereof that displays a three-dimensional image by using an integral imaging.

2. Description of the Related Technology

The integral imaging technology, which was designed by Lippmann for the first time, has been actively developed as one of the next generation three-dimensional image display technologies. Like a holographic method, considered as an ideal three-dimensional display method, the integral imaging technology can provide full parallax and successive observation perspectives. Typically, the integral technology is classified into a pick-up step and a display step. The pick-up step is realized by a two-dimensional sensor, such as a charge coupled device (CCD), and a lens array. A three-dimensional object is provided in front of the lens array. The two-dimensional sensor stores a variety of image information on the three-dimensional object, which has passed through the lens array. This stored image information is used for three-dimensional reproduction. The following display step, an inverse step of the pick-up step, is embodied by a display apparatus, such as an LCD, and another lens array. In the display step, an elemental image, provided from the pick-up step, is displayed on the display apparatus. Image information of the elemental image passes through the lens array, and a three-dimensional image is reproduced in a space.

### SUMMARY OF CERTAIN INVENTIVE ASPECTS

One aspect of the present invention provides a three-dimensional image display apparatus using an intermediate elemental image and a method thereof that can output a high resolution three-dimensional image when a three-dimensional image is displayed.

Another aspect of the present invention provides a three-dimensional image display apparatus using an intermediate elemental image and a method thereof that require no mechanical movement of a lens array by reproducing a three-dimensional image with a plurality of intermediate elemental images generated by an algorithm of a computer.

Another aspect of the present invention provides a three-dimensional image display apparatus using an intermediate elemental image and a method thereof that do not consume long pick-up time by reproducing a three-dimensional image with an elemental image acquired through a single pick-up operation.

Another aspect of the present invention provides a three-dimensional image display apparatus using an intermediate elemental image. The apparatus may have an image input unit (or an intermediate elemental image generator), which generates a plurality of elemental images, having different perspectives, extracted from a three-dimensional object, an image processing unit (or an intermediate elemental image generator), which generates an intermediate elemental image, using parallax information between the elemental images inputted from the image input unit, and an image reproduction unit (or an image reproducer), which reproduces a three-dimensional image corresponding to the three-dimensional object by use of the elemental image and the intermediate elemental image.

The image input unit can also have a first lens array for extracting elemental images of different perspectives from the three-dimensional object, and an image sensor, which stores the elemental images received from the first lens array.

The image reproduction unit can have an image display unit, which displays the elemental image and the intermediate elemental image, and a second lens array, which consists of a plurality of convex lenses reproducing a three-dimensional image corresponding to the three-dimensional object by projecting and overlapping and immersing the elemental image and the intermediate elemental image displayed on the image display unit.

The image reproduction unit can also have an image display unit (or an image display section), which displays the elemental image and the intermediate elemental image, and a second lens array, which consists of a plurality of concave lenses reproducing a three-dimensional image corresponding to the three-dimensional object by reflecting and overlapping and immersing the elemental image and the intermediate elemental image displayed on the image display unit.

The intermediate elemental image can be combined as a linear combination of two adjacent images among the plurality of elemental image.

The intermediate elemental image can be generated by the following formula:

I_{P}(x,y)=(1−α)·I_{L}(x+αd(x,y),y)+·I_{R}(x−(1−α)d(x,y),y)

Here, I_{P} is a pixel of an intermediate elemental image, I_{L} is a pixel of a left image of the two adjacent elemental images, I_{R} is a pixel of a right image of the two adjacent elemental images, d is a spatial difference between I_{L} and I_{R}, and 0≦α≦1.

If the three-dimensional image enlarges the three-dimensional object by n times, the number of the intermediate elemental images generated between the adjacent elemental images can be n−1.

Another aspect of the invention provides an apparatus for generating a three-dimensional image based on elemental images, the apparatus comprising: i) an elemental image generator configured to generate a plurality of elemental images from a three-dimensional object, wherein the elemental images comprise different perspectives, ii) an intermediate elemental image generator configured to generate at least one intermediate elemental image, based on parallax information between the generated elemental images and iii) an image reproducer configured to reproduce a three-dimensional image corresponding to the three-dimensional object based on the elemental images and the at least one intermediate elemental image.

Another aspect of the invention provides a method of generating a three-dimensional image based on elemental images, the method comprising: i) generating a plurality of elemental images from a three-dimensional object, wherein the elemental images comprise different perspectives, ii) generating at least one intermediate elemental image, based on parallax information between the generated elemental images and iii) reproducing a three-dimensional image corresponding to the three-dimensional object based on the elemental images and the at least one intermediate elemental image.

Still another aspect of the invention provides an apparatus for generating a three-dimensional image based on elemental images, the apparatus comprising: i) means for generating a plurality of elemental images from a three-dimensional object, wherein the elemental images comprise different perspectives, ii) means for generating at least one intermediate elemental image, based on parallax information between the generated elemental images and iii) means for reproducing a three-dimensional image corresponding to the three-dimensional object based on the elemental images and the at least one intermediate elemental image.

### BRIEF DESCRIPTION OF THE DRAWINGS

FIG. 1 illustrates a typical system for a three-dimensional image resolution.

FIG. 2 illustrates a three-dimensional image display apparatus in accordance with an embodiment of the present invention.

FIG. 3 illustrates projection and reflection integral imaging display apparatuses that can be applied to embodiments of the present invention.

FIG. 4 illustrates a method of generating an intermediate elemental image in an integral imaging system in accordance with an embodiment of the present invention.

FIG. 5 illustrates a method of generating a two-dimensional intermediate elemental image in an integral imaging system in accordance with an embodiment of the present invention.

FIG. 6. illustrates an elemental image and an intermediate elemental image generated according to parameters different from each other in accordance with an embodiment of the present invention.

FIG. 7 illustrates a principle of enlarging an image corresponding to a three-dimensional object by using an intermediate elemental image in accordance with a first embodiment of the present invention.

FIG. 8 illustrates a system for picking up an elemental image from a three dimensional object in accordance with one embodiment of the present invention.

FIG. 9 illustrates elemental images picked up and enlarged by the system in FIG. 8.

FIG. 10 illustrates the elemental images in FIG. 9 and intermediate elemental images generated from the elemental images.

FIG. 11 illustrates a type of comparing vertically and horizontally generated intermediate elemental images and elemental images in accordance with one embodiment of the present invention.

FIG. 12 illustrates a three-dimensional image display apparatus for image enlarging in accordance with one embodiment of the present invention.

FIG. 13 illustrates an enlarged image in accordance with one embodiment of the present invention.

FIG. 14 illustrates a general integral imaging method for reproducing a three-dimensional image by using a computer.

FIG. 15 illustrates a structure of a system for reproducing a three-dimensional image by using a computer in accordance with a second embodiment of the present invention.

FIG. 16 illustrates an integral imaging method for reproducing a three-dimensional image by using a computer in accordance with one embodiment of the present invention.

FIG. 17 illustrates an optically acquired elemental image and a combined intermediate elemental image in accordance with one embodiment of the present invention.

FIG. 18 illustrates a three-dimensional images reconstructed from an elemental image by using a computer for comparison in accordance with one embodiment of the present invention.

### DETAILED DESCRIPTION OF CERTAIN INVENTIVE EMBODIMENTS

Although the integral imaging technology provides many benefits, a high resolution three dimensional image is not easy to reproduce because it is limited to completely pick up image information from a three-dimensional object. Generally, the resolution of a three dimensional image depends on the number of elemental images. This means that many elemental images are used to reproduce a high resolution three-dimensional image.

The moving array-lenslet technique (MALT), which increases the resolution of a three-dimensional reproduction image, was designed by Javidi group in 2002. The MALT reproduces a high resolution three-dimensional image by acquiring many elemental images through a time-multiplexing method and representing the elemental images, acquired through the time-multiplexing method, on a display panel at a high speed while a lens array contrarily moves. A recent research reports a method that applies the MALT to the enlargement of a three-dimensional reproduction image. An operation of enlarging the reproduction image is performed by the MALT, which controls spatial ray sampling in the pick-up step of the integral technology. The MALT enlarges the size of an image corresponding to a three-dimensional object, displayed in a spatial coordinate of three axes, by applying the same ratio to each axis. On the other hand, the display step of the three-dimensional image is realized by a fixable lens array to get an enlarged image. The resolution of a three-dimensional reproduction image in the integral imaging technology is determined by many system variables, such as the diffraction, the lenslet aberration, the system arrangement, a pixel of two-dimensional sensor and a display panel. The diameter of a basic lens forming a lens array is one of the fundamental variables for restricting the reproduced three-dimensional image resolution. From the Nyquist sampling theory, the resolution in the integral imaging technology is restricted by a formula, βnyq=L/2P, whereas P is the size of basic lens, and L is the distance between a user and the lens array. Here, if P is randomly decreased to increase the resolution, a viewing angle is relatively reduced, and the diffraction of the basic lens is generated. The MALT is designed to recover this restriction.

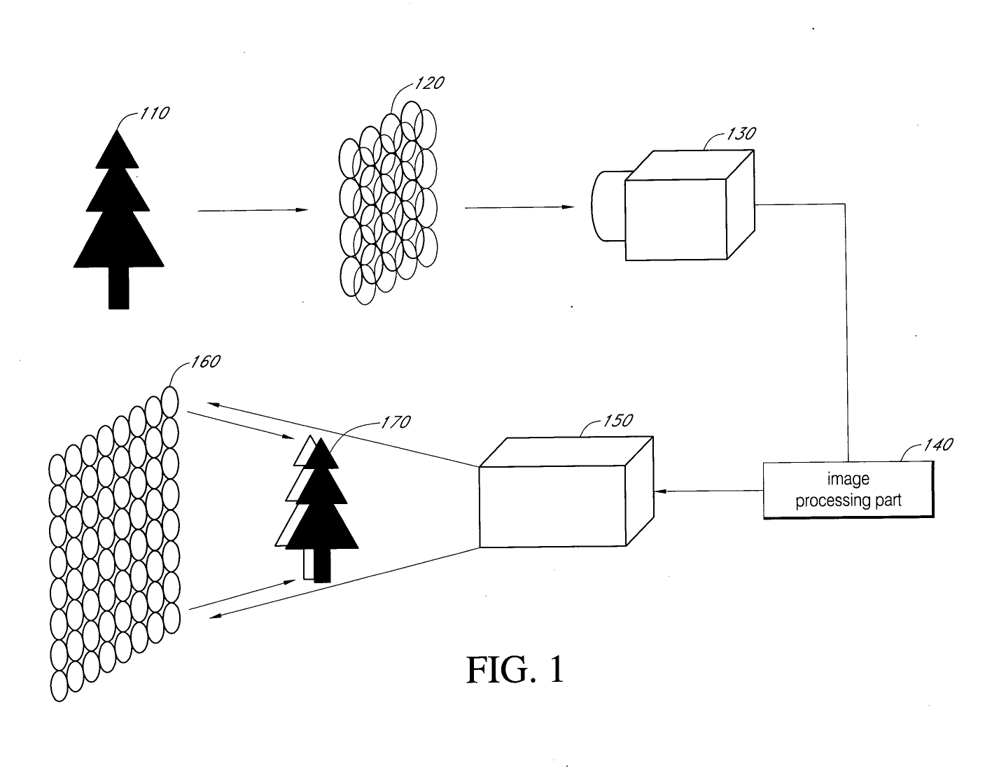

FIG. 1 illustrates a typical MALT system for increasing the resolution of a three-dimensional image. Referring to FIG. 1, a three-dimensional object 110, a first lens array 120, an image sensor 130, an image processing unit 140, an imaging display unit 150, a second lens array 160 and a three-dimensional image 170 are illustrated.

Light projected from the three-dimensional object 110 passes through the first lens array, and the light is stored in the image sensor 130 as a plurality of elemental images. The elemental images undergo the process of the image processing unit 140 for the size and arrangement of an image, and are outputted from the image display unit 150. Then, the elemental images are displayed as the three-dimensional image 170 by the second lens array 160.

In the pick-up step using the MALT, the spatial sampling ratio is increased by vibrating the lens array upwardly; downwardly, leftwardly and rightwardly. At this time, the two-dimensional sensor is settled. A two-dimensional sensor for high speed pick up may be needed to promptly write an unsettled elemental image provided through the vibrating lens array. The MALT can be used to identically analyze three axes of spatial coordinate and enlarge an image corresponding to the three-dimensional object. Here, an integrated image system of projector type can be used to provide an image without distortion and wide perspective angle. The integrated image system of projector type uses a convex mirror lens array. In this system, an operation of enlarging the reproduction image is performed by the MALT of the pick-up step. For example, assuming that an image corresponding to the three-dimensional object is enlarged n times, an elemental image needs to be picked up at an n×n sampling point by using the MALT. Here, n=P/S, whereas P is the diameter of a basic lens, and S is the sampling interval. The pick-up step is repeated within the size of one basic lens. All n×n picked elemental images are transmitted to the display system through a transmission line. To display an enlarged three-dimensional image, a new combination elemental image is formed by the image processing unit 140 with the n×n elemental images.

However, since this MALT requires a multi-steps pick-up operation by using the vibration of the lens array in the pick-up step, it is not easy to embody the integral imaging system in real time due to an error caused by mechanical movement or long pick-up time.

That is, although the MALT can be used to enlarge the three-dimensional combination image by using elemental images provided through the pick-up step, the mechanical movement and long pick-up time function as a blocking factor while the system is optimized in real time.

Hereinafter, the embodiments of a three-dimensional image display apparatus using an intermediate elemental image and a method thereof will be described with reference with the accompanying drawings, examples of which are illustrated in the accompanying drawings, wherein like reference numbers refer to like elements throughout. The redundant description thereof will be omitted.

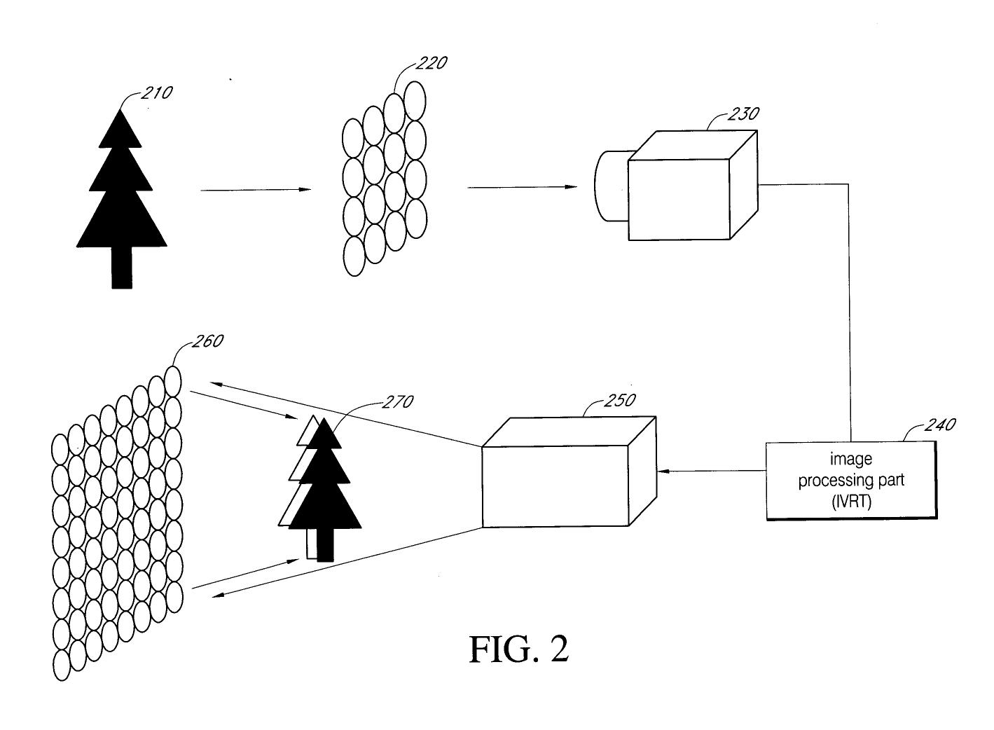

FIG. 2 illustrates a three-dimensional (3D) image display apparatus in accordance with an embodiment of the present invention. Referring to FIG. 2, a 3D object 210, a first lens array 220, an image sensor 230, an image processing unit 250, a second lens array 260 and a 3D image 270 are illustrated.

A 3D image display apparatus using an intermediate elemental image in accordance with the integral imaging technology comprises a photographing unit and a display unit. The photographing unit includes a first lens array 220, which forms an image of a different perspective from the 3D object 210, and the image sensor 230, which stores an elemental image immersed by the first lens array 220. The display unit includes an image reproducing unit, which displays the elemental image stored in the image sensor 230, and a second lens array 260, which immerses the elemental image displayed from the image reproducing unit 250 and reproduces the immersed elemental image as the 3D image 270. The first lens array 220 and the second lens array 260 are formed by combining a plurality of lenses.

The image processing unit 240 combines intermediate elemental images by using an intermediate perspective reconstruction technique (IPRT). Elemental images, picked up once, can be transmitted in real time to the image processing unit 240 through pick-up devices that are used in a present communication channel. Since the elemental images that are picked up once cannot be used for the enlarging function of the integral imaging technology, the number of the elemental images is increased by using the IPRT, which generates the intermediate elemental image by the calculation of a computer. The use of the IPRT makes it possible to generate in real time the intermediate elemental image thanks to the recent prompt development of hardware and to process in real time an original elemental image and newly generated intermediate elemental image.

The integral imaging system in accordance with one embodiment of the present invention can enlarge a 3D reproduction image through a simple computer calculation without a conventional multi pick-up step such as the MALT and a mechanical operation. In particular, with a display method in accordance with one embodiment of the present invention, the number of elemental images acquired through the one-time-pick-up operation is increased with the IPRT. The increased plurality of elemental images is additionally combined. This method can provide the same efficiency as the MALT, which reproduces a 3D image by using a plurality of elemental images. Accordingly, the system in accordance with one embodiment of the present invention can be used for the real-time enlarging integral imaging system because additional time is not required for the mechanical movement of lens array and the pick-up operation of images corresponding to the 3D object. Hereinafter, an operation method of this system will be described, and then, the embodiments and results thereof will be described by way of example of an enlarging display experiment.

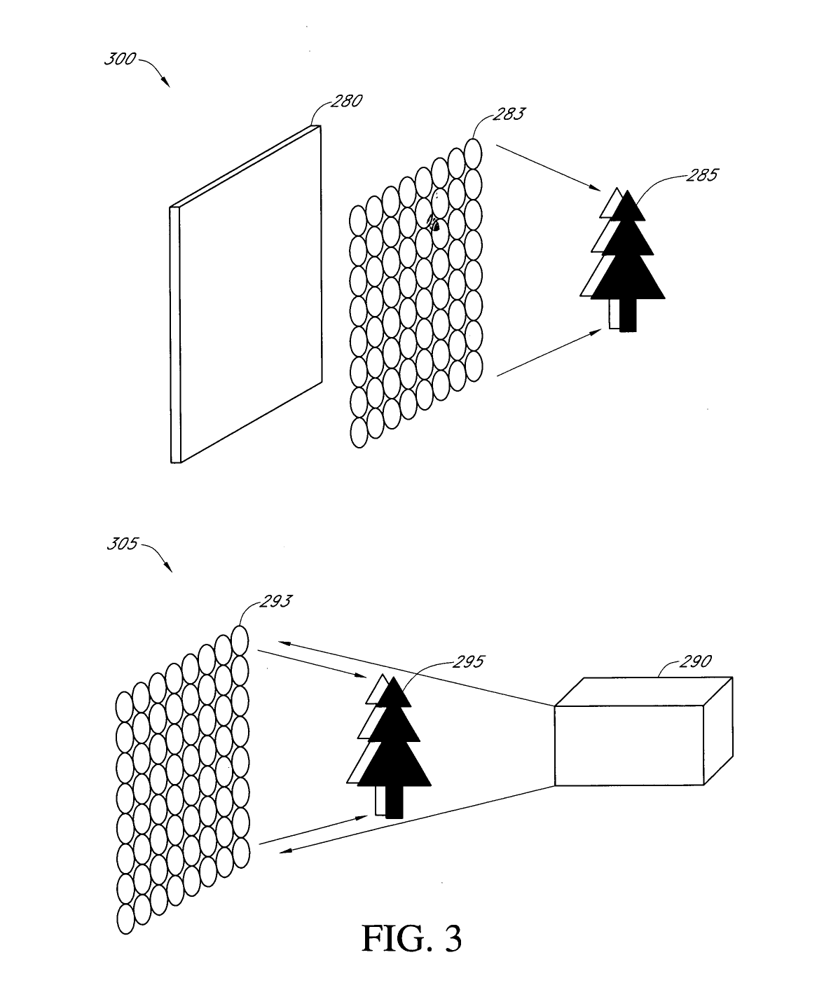

FIG. 3 illustrates projection and reflection integral imaging display apparatuses that can be applied to embodiments of the present invention. Referring to FIG. 3, a display apparatus 280, a projection lens array 283, 3D images 285 and 295, a projection device 290 and a reflection lens array 293 are illustrated for comparison.

In (a) of FIG. 3, which shows the projection integral imaging display apparatus, the projection lens array 283 is provided in front of the display apparatus 280. With this configuration, the light emitted from the display apparatus 280 passes through the projection lens array 283. Then, the 3D image 285 is formed by combining each elemental image.

In (b) of FIG. 3, which shows the reflection integral imaging display apparatus, the 3D image 295 is formed between the projection device 290 and the reflection array 293. The reflection array 293 is formed by coating a mirror to a surface of the projection lens array 283. A concave mirror can replace the reflection lens array 293. With this configuration, the light emitted from the projection device 290 is reflected in the concave mirror and concentrated to form the 3D image 285. A big screen projection integral image system can employ the reflection integral imaging system, for example.

The reflection integral imaging display apparatus in (b) of FIG. 3 generally provides an image without distortion and a wide viewing angle as compared with the projection integral imaging display apparatus in (a) of FIG. 3. Both the projection and reflection integral imaging display apparatuses in (a) and (b) of FIG. 3 can be applied to the 3D image display apparatus.

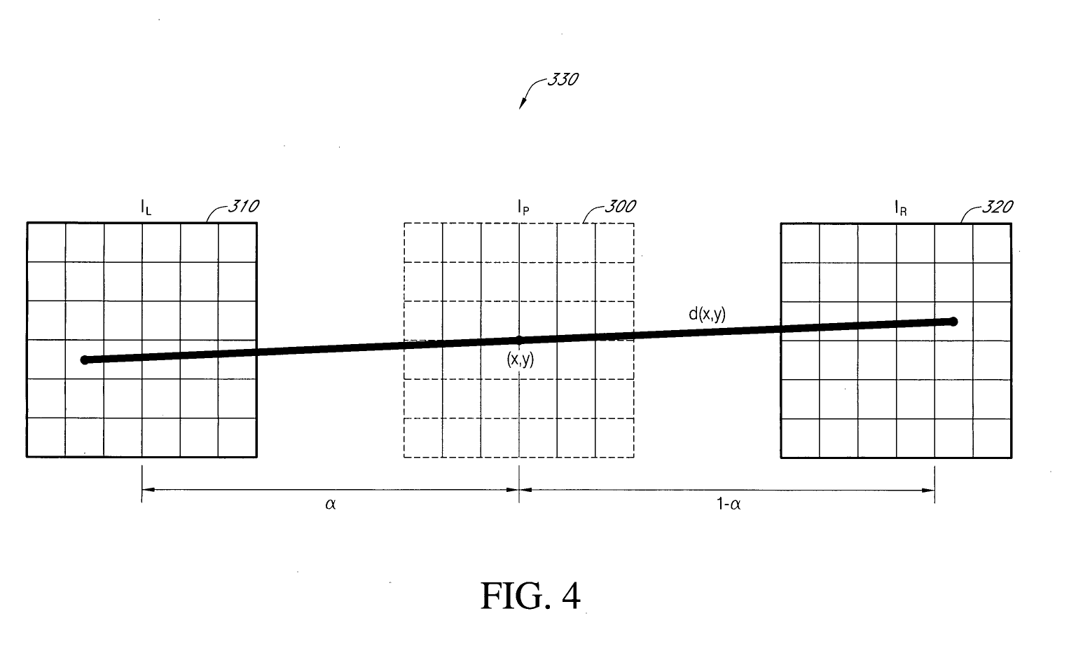

FIG. 4 illustrates a method of generating an intermediate elemental image in an integral imaging system in accordance with an embodiment of the present invention. Referring to FIG. 4, a left image 310 and a right image 320 of two adjacent images in a plurality of elemental images and an intermediate elemental image 330 of the left and right images 310 and 320 are illustrated.

The left image 310 and the right image 320 are appointed as I_{L}(x,y) and I_{R}(x,y), respectively. The disparity of the two images 310 and 320 is d(x,y). The intermediate elemental image 330 is appointed as I_{P}(x,y). Here, the disparity d(x,y) can be extracted with various methods. The corresponding intermediate elemental image 330 is positioned at a distance α standardized from the left image 310. For example, if the distance from the left perspective to the right perspective is converted into 1, α is within 0 to 1, that is 0≦α≦1. An intermediate-perspective image can be combined as a linear combination of the two images with the interpolation. The following formula (I) shows the method of the interpolation with a perspective α.

I_{P}(x,y)=(1−α)·I_{L}(x+αd(x,y),y)+α·I_{R}(x−(1−α)d(x,y),y) (1)

Here, I_{P} is the intermediate elemental image pixel. I_{L} is a pixel of the left image of the two adjacent elemental images. I_{R} is a pixel of the right image of the two adjacent elemental images. d is the difference between I_{L} and I_{R} (i.e. the disparity), whereas 0≦α≦1.

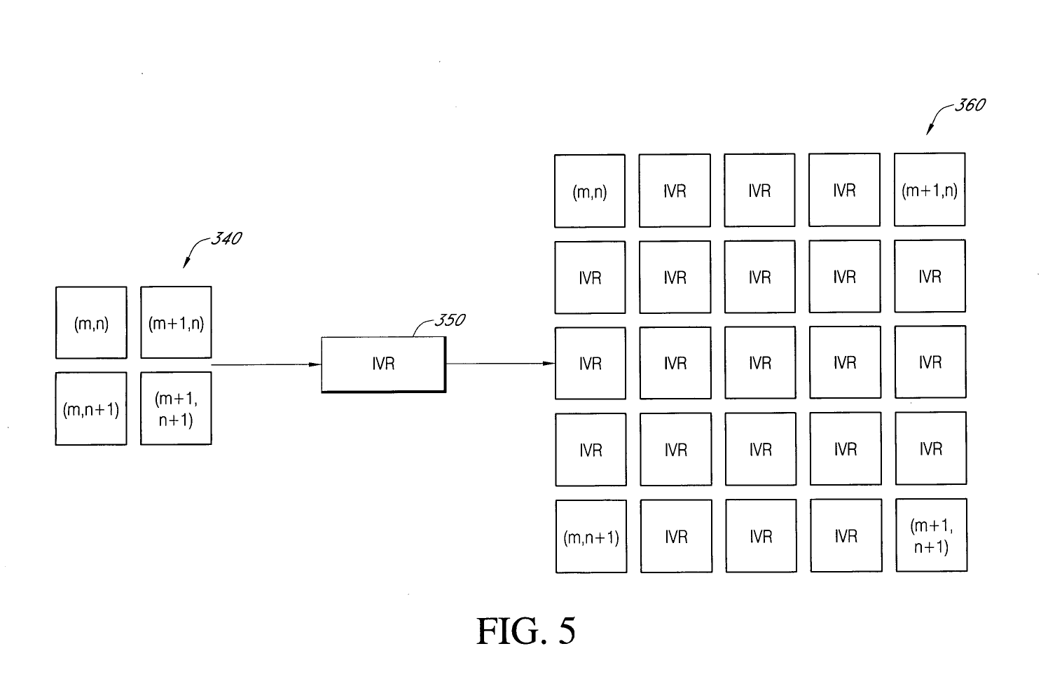

FIG. 5 illustrates a two-dimensional intermediate elemental image in accordance with an embodiment of the present invention. Referring to FIG. 5, an elemental image 340 generated from the 3D object, an intermediate elemental image 350 and an elemental image set 360, including the intermediate elemental image 350, for reproducing a 3D image are illustrated.

An IPRT is performed by applying a different weighted value to the disparity information in accordance with an intermediate-perspective for estimating and generating disparity information of a different perspective image. Here, a method of generating an intermediate image of three perspectives between each elemental image is illustrated. For example, 12 outside intermediate elemental images are generated in vertical and horizontal dimensions of the intermediate image of the respective elemental images. Then, 9 inside intermediate elemental images are generated. Accordingly, the elemental image set 360 having 25 elemental images is generated from 4 elemental images 340 formed from the 3D object.

Here, the (i,j)^{th} elemental image is appointed as E_{i,j}(x,y), whereas x and y indicate pixel positions of the respective elemental images. i and j correspond to the number of lenses that are vertically and horizontally disposed. The IPRT has been mainly described for two adjacent elemental images, but is not limited thereto. Each intermediate elemental image corresponding to α, which is variable, can be acquired from the formula (1) by using E_{i,j}(x,y) and E_{i+1,j}(x,y). α is used as a size adjusting parameter. For example, if an image corresponding to a 3D object is enlarged n times,

$$Δ a = \frac{1}{n}$$

and the number of the intermediate elemental images becomes n−1.

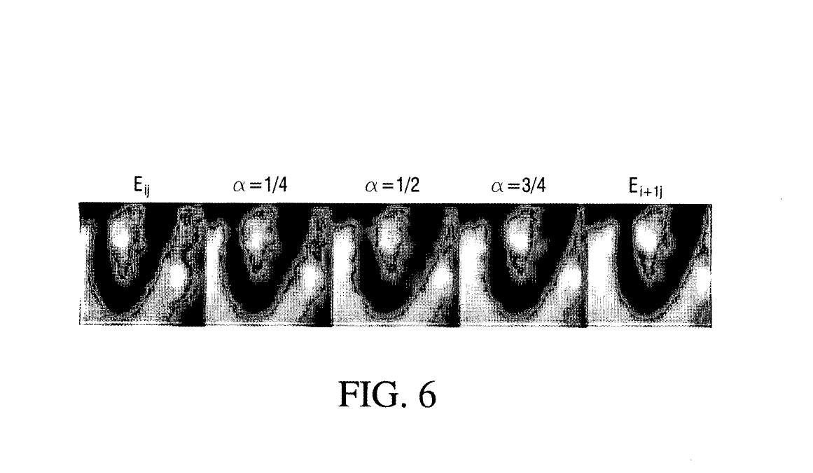

FIG. 6 illustrates elemental images E_{i,j}(x,y), E_{i+1,j}(x,y)) and intermediate elemental images generated in accordance with different parameters (α=¼, ½, ¾). The disparity between the elemental images (E_{i,j}(x,y), E_{i+1,j}(x,y)) is gradually interpolated by the intermediate elemental images generated in accordance with different parameters (α=¼, ½, ¾).

Hitherto, the drawings that generally illustrate the 3D image display apparatus using the intermediate elemental image and a method thereof have been described. Hereinafter, detailed embodiments (i.e. experiments) of the 3D image display apparatus using the intermediate elemental image and a method thereof will be described with reference to the drawings. Embodiments of the present invention are classified into a first method of enlarging an image corresponding to a 3D object by using an intermediate elemental image, and a second method of increasing the resolution of the image, which are below described in order.

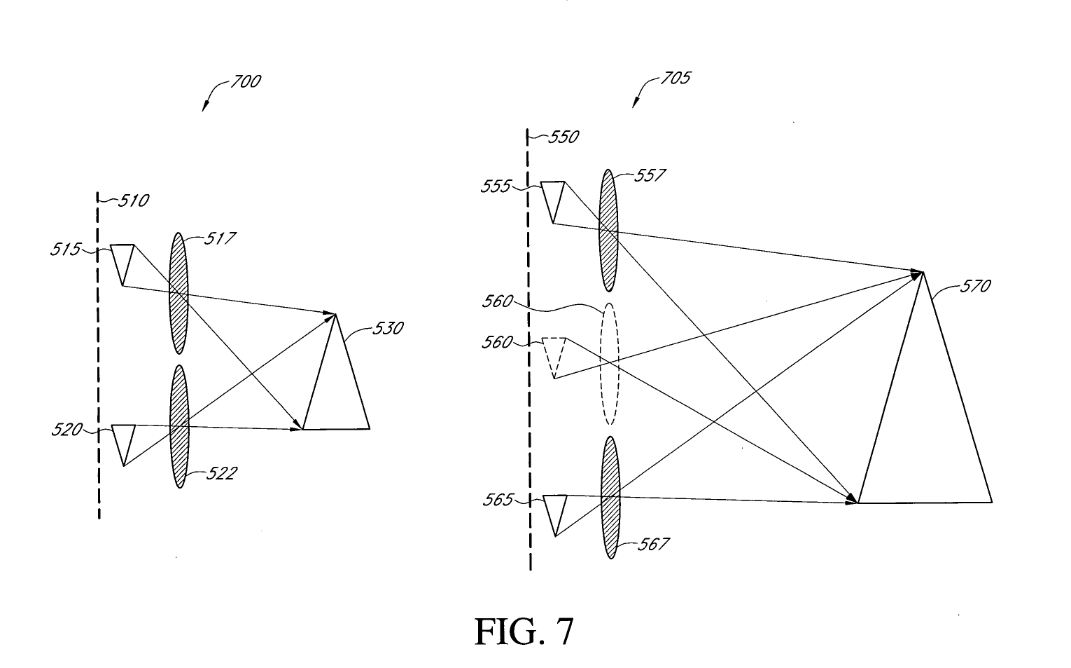

FIG. 7 compares a case of using an elemental image only and another case of using an intermediate elemental image, when enlarging an image corresponding to a three-dimensional object in accordance with a first embodiment of the present invention. Referring to FIG. 7, display apparatuses 510 and 550, elemental images 515, 520 and 555, lens arrays 517, 522, 557, 562 and 567, 3D images 530 and 570 and an intermediate elemental image 560 are illustrated.

In the case of using elemental images 515 and 520 only to generate the 3D image 530 in (a) of FIG. 7, the elemental images 515 and 520 outputted from the display apparatus 510 are passed through the lens arrays 517 and 520. Then, the elemental images 515 and 520 forms the 3D image 530 of a size corresponding to a focus distance of lens and a distance between the elemental images 515 and 520.

In the case of using the elemental images 555 and 565 and the intermediate elemental image 560 to generate the 3D image 530 in (b) of FIG. 7, where the intermediate elemental image 560 is provided between the elemental images 555 and 565, the distance between the elemental images 555 and 565 becomes larger than the distance between the elemental images 515 and 520. Accordingly, considering a top point and a bottom point of the combined 3D image 570, the paths of light passing through each lens array geometrical-optically extend more than the 3D image 530, and cause an increase in the overall 3D image 530. Here, the intermediate elemental image 560, inserted between the elemental images 555 and 565, can increase the resolution. If a 3D image 570 is enlarged 3 times as much as the 3D image 530, the number of intermediate elemental images that are inserted into elemental images becomes n−1. That is, the distance between the elemental images 555 and 565 is increased n times as much as the initial distance therebetween, the 3D image 570 is enlarged n times as much as the 3D image 530. The number of the intermediate elemental images, which are inserted between the elemental images 555 and 565, is n−1. A detailed embodiment in accordance with the image enlarging method using this intermediate elemental image 560 is described below.

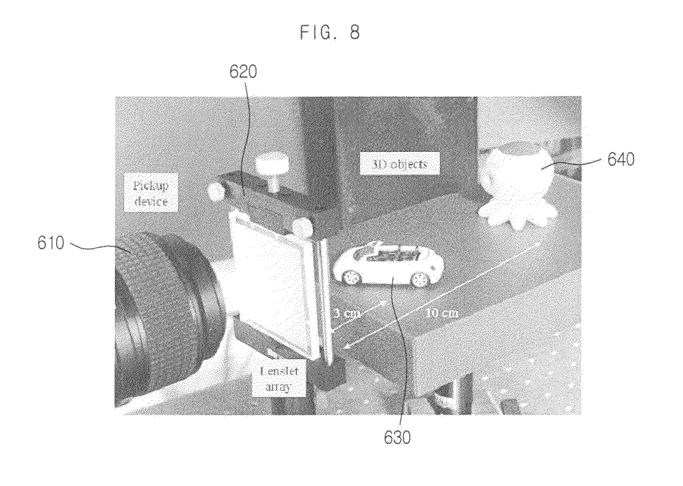

FIG. 8 illustrates a system for picking up an elemental image from a three dimensional object in accordance with one embodiment of the present invention. Referring to FIG. 8, the elemental image is captured by an image sensor 610 (e.g. a CCD camera) through picking up a lenslet array 620. For example, a 3D object consists of two objects. That is, a toy vehicle 630 is separated by 3 cm from the lenslet array 620, and an octopus doll 640 is separated by 10 cm from the lenslet array. The lenslet array has a size of 33×25. Each lenslet is mapped with a size of 30×30 by the CCD camera. The focus distance and magnification of lens are formed by 3 mm and 1.08 mm, respectively.

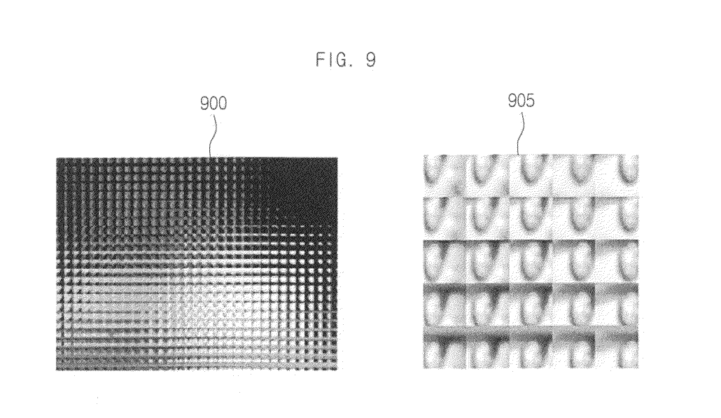

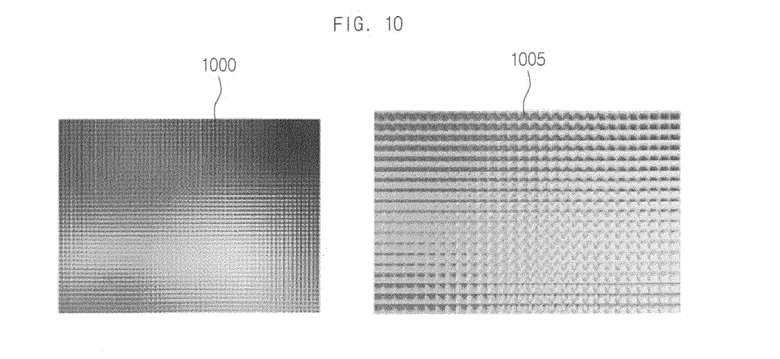

FIG. 9 illustrates elemental images picked up and enlarged by the system in FIG. 8. Referring to FIG. 9, an output screen in (a), on which the picked elemental images are displayed, has a pixel size of 990×750. Enlarged elemental images of a tire of the toy car 530 are displayed on the screen for the enlarged elemental images in (b). Here, every elemental image has a perspective of the respective 3D object. FIG. 10 illustrates intermediate elemental images generated from the elemental images in FIG. 9. Illustrated in (a) and (b) of FIG. 10 are screens that display the intermediate elemental images generated from the elemental images in FIG. 9 by using 3 different a's (n=4).

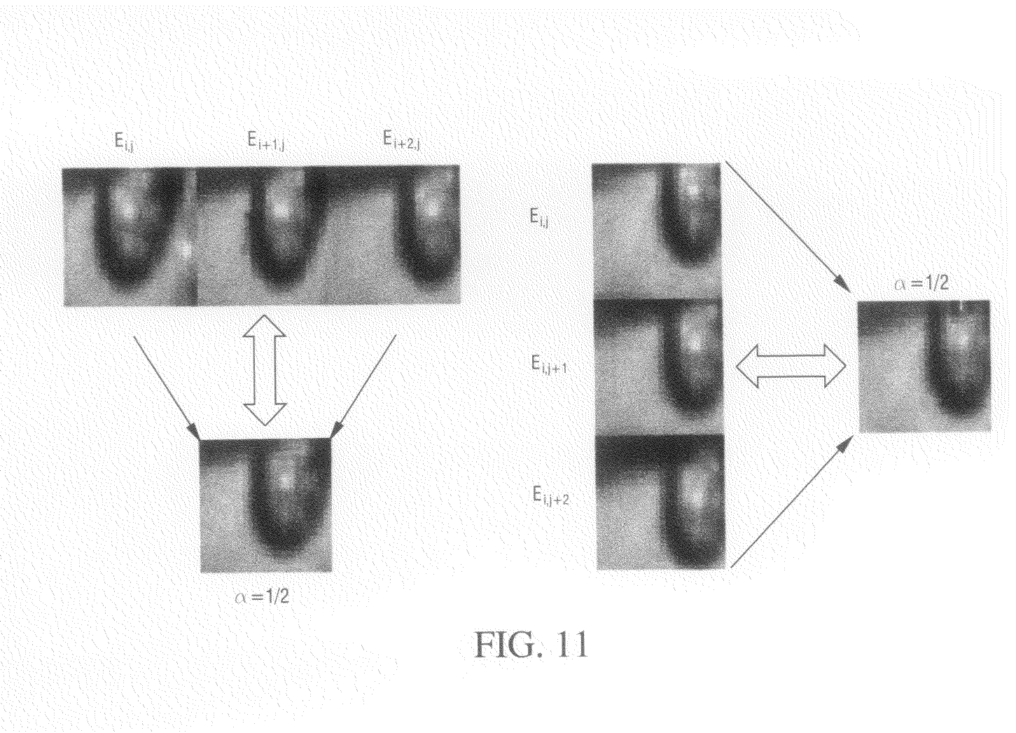

FIG. 11 illustrates a method for image quality comparison of the intermediate elemental image vertically and horizontally calculated and produced from an elemental image in accordance with one embodiment of the present invention.

Referring to (a) of FIG. 11, horizontally adjacent elemental images (Ei,j), (Ei+1,j) and (Ei+2,j) are successively illustrated. The middle-positioned elemental image (Ei+1,j) of these elemental images is used. Referring to (b) of FIG. 11, vertically adjacent elemental images ((Ei,j), (Ei,j+1), (Ei,j+2) are illustrated. The middle-positioned elemental image (Ei,j+1) of these elemental images is used. Here, since α=½, the 3D image, combined in accordance with the position of the lens array, can be enlarged twice as much. The horizontally adjacent elemental images (Ei,j), (Ei+1,j) and (Ei+2,j) and the vertically adjacent elemental images ((Ei,j), (Ei,j+1), (Ei,j+2) are extracted by the lens array. The intermediate elemental image is calculated by a computer with (Ei,j) and (Ei+2,j) in accordance with the IPRT, and is compared with (Ei+1,j). As the result of all reference values is repeated, an average peak signal to noise ratio (PSNR) of 36.08 is taken. Here, the PSNR is generally used to measure the image loss. The image loss is calculated by using an average square error of between pixels of the original elemental image and the generated intermediate elemental image. This result value shows that the image loss is not much in the integral imaging system when reproducing a 3D image.

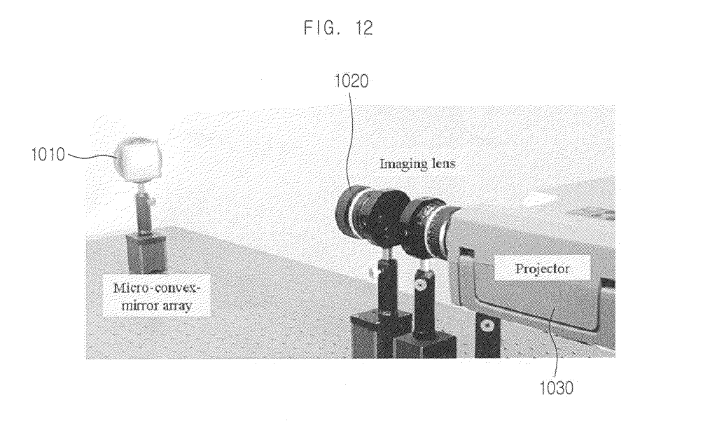

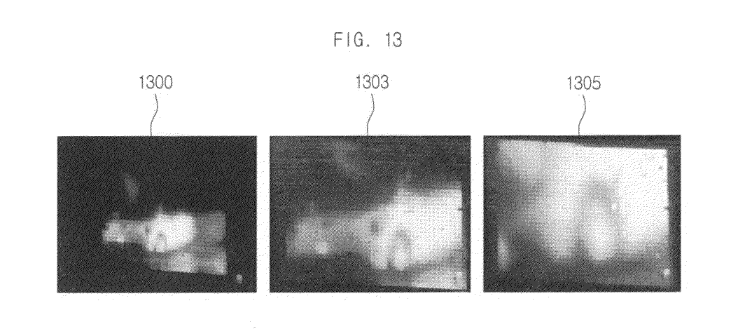

FIG. 12 illustrates a three-dimensional image display apparatus for image enlarging in accordance with one embodiment of the present invention, and FIG. 13 illustrates an image that is enlarged twice and three times as much by the system in FIG. 12.

The display apparatus comprises a micro block mirror array 1010, an imaging lens 1020 and a projector 1030 to enlarge the 3D image by using the intermediate elemental images generated by the IPRT. The display projector 1030 has the resolution of 1280×1024. The micro mirror array 1010, used for a lenslet array screen, is formed by coating a mirror on a surface of the projection lens array. The size and clearness of respective elemental images projected from the projector 1030 are adjusted by the imaging lens 1020. Then, the elemental images, which are reflected in the micro block mirror array, are combined into the 3D image. An original size image, a twice-enlarged image and a three-times-enlarged image are illustrated in (a), (b) and (c), respectively, of FIG. 13. This experiment shows that intermediate elemental images generated by the IPRT can be used to enlarge a 3D image.

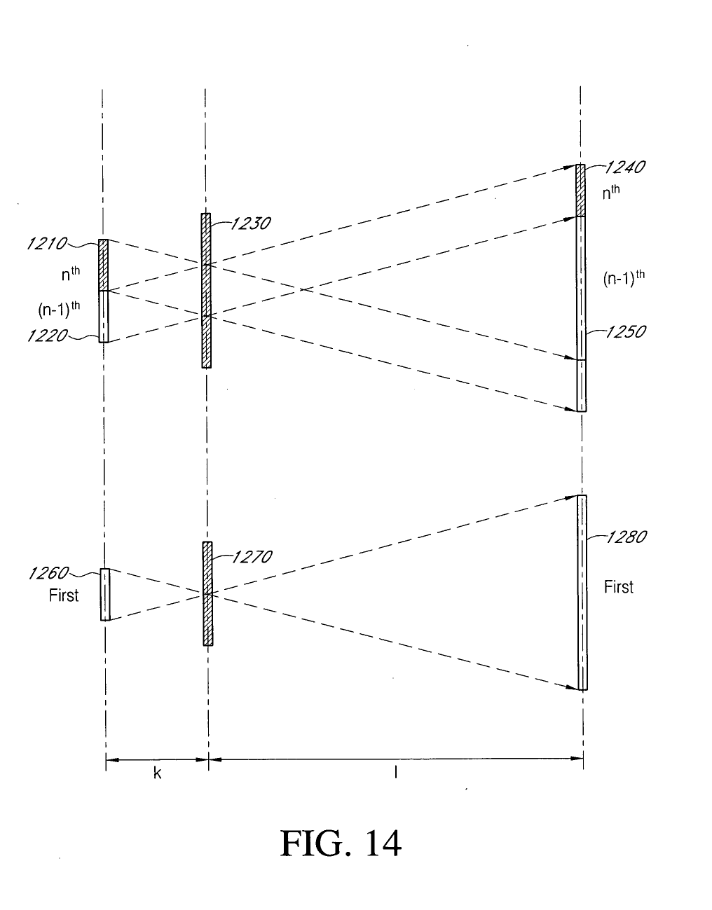

FIG. 14 illustrates a general integral imaging method for reproducing a 3D image by using a computer and a pin hole array.

The integral imaging method represents the 3D image by receiving information on light of the 3D space with a micro lens array or the pin hole array. The intensity and direction of the light passing through each lens or pin hole array are written by using an optical sensor such as a CCD to receive information on the light of an object in the 3D space with the integral image method. Each elemental image is passed through the same lens or pin hole array as used for extracting the elemental image to combine the elemental image. By using this combined information (i.e. elemental image) the 3D image is reproduced.

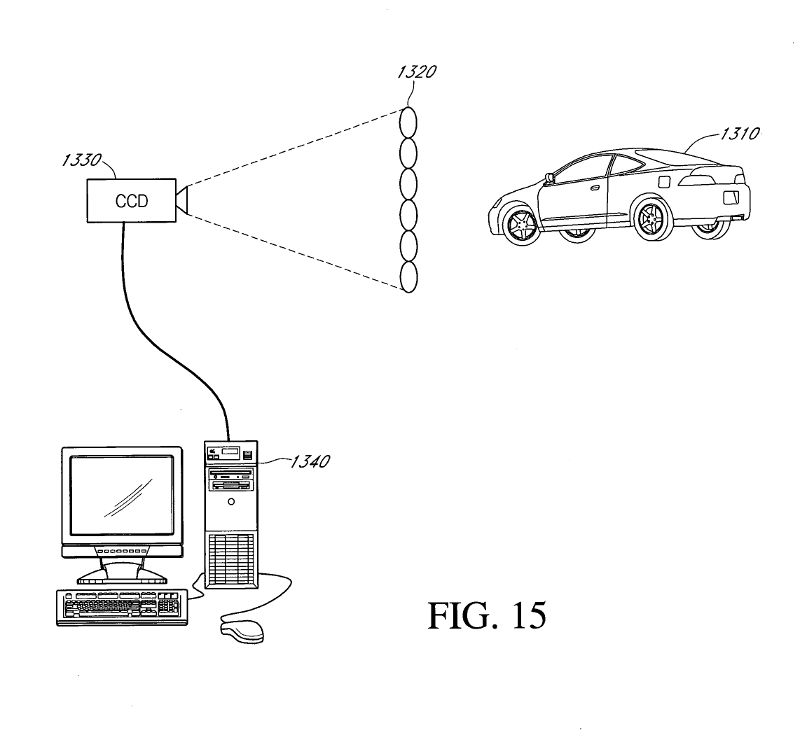

Here, the 3D image is extracted by reproducing and combining the pre-generated elemental image with the computer. That is, a reproducing method using the computer that copies the existing optical reproducing method of the elemental image can be used. First, the method of acquiring the elemental image is identical to the optical reproducing method. However, when the acquired elemental image is reproduced, a method, for modeling the use of the lens (or pin hole) and enlarging and inverting and overlapping each elemental image, can be used. An enlarging rate M of the elemental image is determined by a ratio of a reproduced distance l (i.e. a distance between virtual pin hole arrays 1230 and 1270 and reproduced image area 1240, 1250 and 1280) to a distance k between the elemental images 1210, 1220 and 1260 and the virtual pin hole arrays 1230 and 1270 (i.e. M=l/k). Referring to FIG. 15, when reproducing an increased number of elemental images, generated to increase the resolution, the 3D image reproducing system using the computer includes a 3D object 1310, a lens array 1320, an image sensor 1330 and a computer 1340.

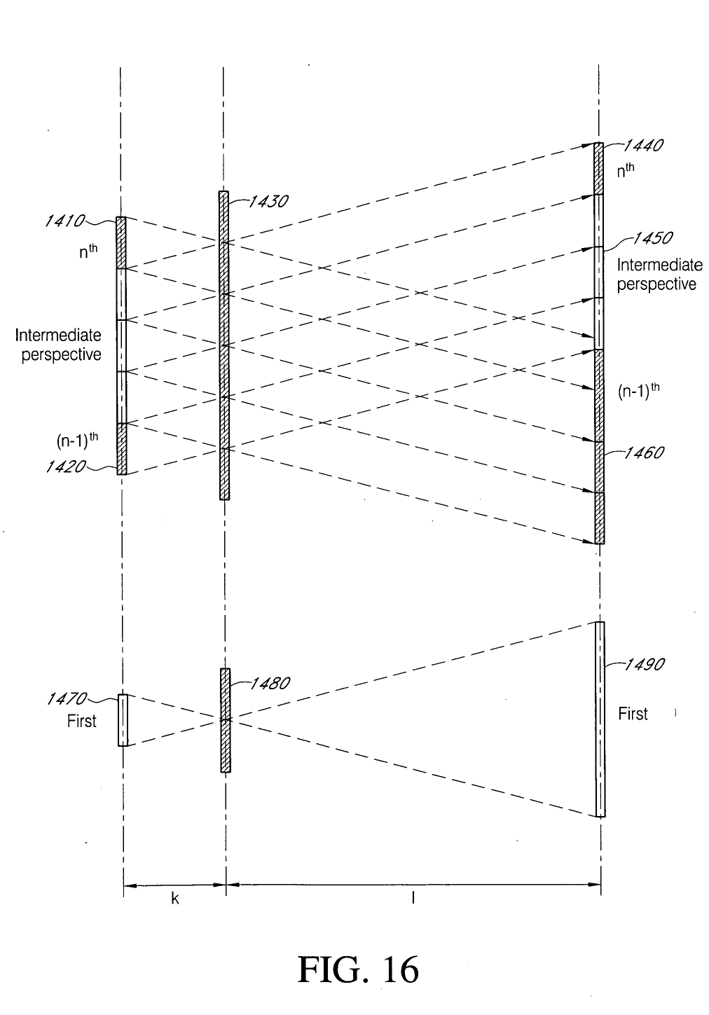

FIG. 16 illustrates an integral imaging method for reproducing a three-dimensional image by using a computer in accordance with one embodiment of the present invention. Referring to FIG. 16, elemental images 1410, 1420 and 1470, an intermediate elemental image 1405, pin hole arrays 1430 and 1480 and reproduced image areas 1440, 1450, 1460 and 1490 are illustrated.

As described above, the enlarging rate M is l/k, and an intermediate elemental image 1405 is generated and disposed between each elemental image 1410, 1420 and 1470. FIG. 16 illustrate that a first elemental image 1470, an (n−1)^{th} elemental image 1420, an n^{th} elemental image 1410 and the intermediate elemental image 1405 pass through the pin hole arrays 1430 and 1480 and a first reproduced image 1490, an (n−1)^{th} reproduced image 1460, an n^{th} reproduced image 1440 and a reproduced image 1450 of the intermediate elemental image 1405. Here, the method of reproducing the generated intermediate elemental image and elemental image is to enlarge at a distance and invert and overlap the intermediate elemental image 1405 generated between conventional elemental images reproduced by a computer.

Here, the 3D image reproducing method in the integral imaging method, in case that maximum elemental images are overlapped, can improve the resolution of the reproduced 3D image. Accordingly, in case that the intermediate elemental image generated between each elemental image by the IPRT, the increasing of the number of overlapped elemental images makes the improvement of the 3D image resolution.

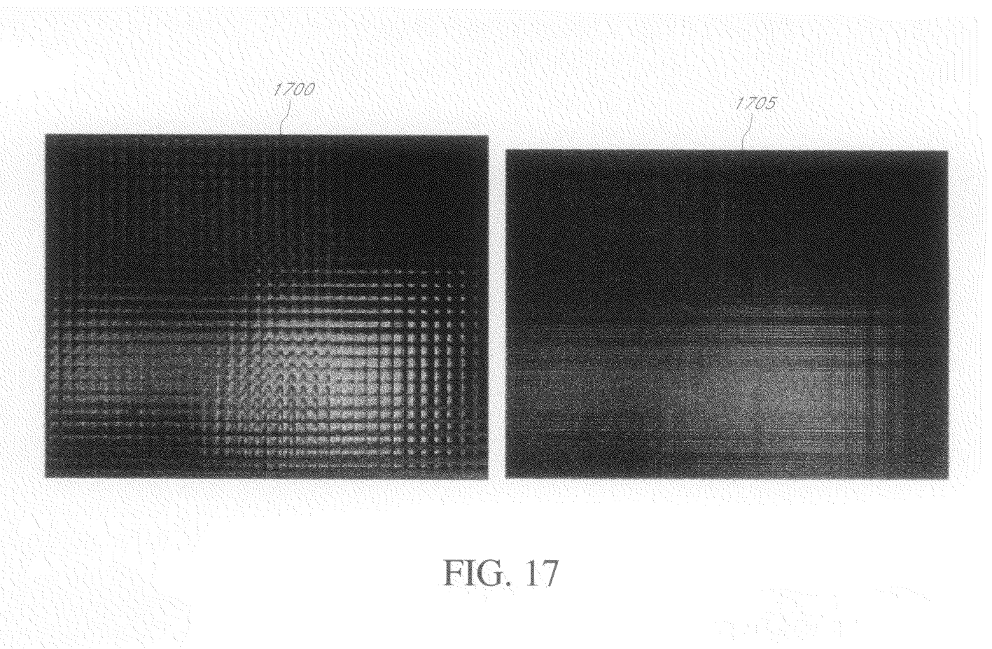

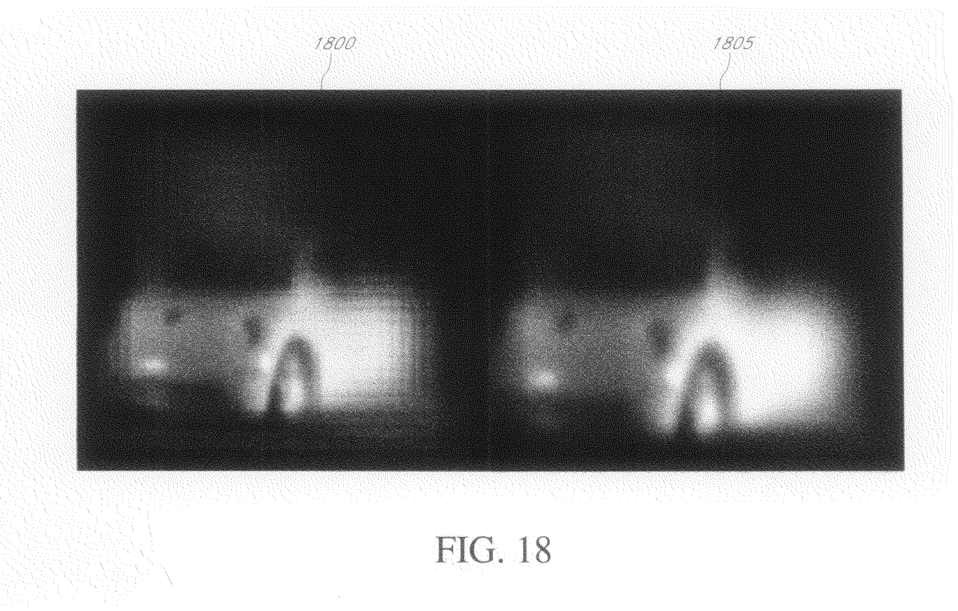

FIG. 17 illustrates an optically acquired elemental image and a combined intermediate elemental image in accordance with one embodiment of the present invention, and FIG. 18 illustrates a 3D images reconstructed from an elemental image by using a computer for comparison in accordance with one embodiment of the present invention.

Referring to FIG. 17, the elemental image taken from the 3D object through the lens array and the intermediate elemental image generated by the IPRT are illustrated in (a) and (b), respectively. The elemental image taken from the 3D object through the lens array in (a) of FIG. 17 has the resolution of 990×750. Each elemental image consists of a pixel of 30×30.

Referring to FIG. 18, a first case, in which the 3D image is reproduced with the computer by using the elemental image only, and a second case, in which the 3D image is reproduced by using the intermediate elemental image, are illustrated in (a) and (b), respectively. The second case has a higher resolution than the first case. As a result, it is easily observed that the second case that applies the IPRT can have the improved resolution.

Embodiments of the present invention by no means limit or restrict the present invention. It is evident that a large number of permutations are possible by any person of ordinary skill in the art within the spirit of the present invention.

As described above, a three-dimensional image display apparatus and a method thereof in accordance with at least one embodiment of the present invention can output a high resolution three-dimensional image when reproducing a three-dimensional image.

Also, with a three-dimensional image display apparatus and a method thereof in accordance with at least one embodiment of the present invention, a three-dimensional image can be reproduced without the mechanical movement of a lens array by using a plurality of intermediate elemental images generated by a computer algorithm.

In addition, with a three-dimensional image display apparatus and a method thereof in accordance with at least one embodiment of the present invention, a three-dimensional image can be reproduced without a long-pick-up time by using an elemental image acquired through a one-time-pick-up operation.

Hitherto, although embodiments of the present invention have been shown and described, it will be appreciated by any person of ordinary skill in the art that a large number of permutations and other equivalent embodiments are possible without departing from the principles and spirit of the invention, the scope of which is defined in the appended claims and their equivalents.

What is claimed is:

1. An apparatus for generating a three-dimensional image based on elemental images, the apparatus comprising:
an elemental image generator configured to generate a plurality of elemental images from a three-dimensional object, wherein the elemental images comprise different perspectives;
an intermediate elemental image generator configured to generate at least one intermediate elemental image, based on parallax information between the generated elemental images; and
an image reproducer configured to reproduce a three-dimensional image corresponding to the three-dimensional object based on the elemental images and the at least one intermediate elemental image.

2. The apparatus of claim 1, wherein the elemental image generator comprises:
a first lens array configured to extract elemental images of different perspectives from the three-dimensional object; and
an image sensor configured to store the elemental images received from the first lens array.

3. The apparatus of claim 1, wherein the image reproducer comprises:
an image display section configured to display the elemental images and the intermediate elemental image; and
a second lens array, comprising a plurality of convex lenses, configured to reproduce a three-dimensional image corresponding to the three-dimensional object by projecting and overlapping and immersing the elemental images and the intermediate elemental image displayed on the image display section.

4. The apparatus of claim 1, wherein the image reproducer comprises:
an image display section configured to display the elemental images and the intermediate elemental image; and
a second lens array, comprising a plurality of concave lenses, configured to reproduce a three-dimensional image corresponding to the three-dimensional object by reflecting and overlapping and immersing the elemental images and the intermediate elemental image displayed on the image display section.

5. The apparatus of claim 1, wherein the intermediate elemental image generator is further configured to perform a linear combination of two adjacent elemental images so as to generate the intermediate elemental image.

6. The apparatus of claim 5, wherein the intermediate elemental image generator is further configured to generate the at least one intermediate elemental image based on the following formula:
I_{P}(x,y)=(1−α)·I_{L}(x+αd(x,y),y)+α·I_{R}(x−(1−α)d(x,y),y) (1)
whereas I_{P} is a pixel of an intermediate elemental image, I_{L} is a pixel of a left image of the two adjacent elemental images, I_{R} is a pixel of a right image of the two adjacent elemental images, d is a spatial difference between I_{L} and I_{R}, and 0≦α≦1.

7. The apparatus of claim 1, wherein, if the three-dimensional image enlarges the three-dimensional object by n times, the number of the at least one intermediate elemental image generated between the adjacent elemental images is n−1.

8. A method of generating a three-dimensional image based on elemental images, the method comprising:
generating a plurality of elemental images from a three-dimensional object, wherein the elemental images comprise different perspectives;
generating at least one intermediate elemental image, based on parallax information between the generated elemental images; and
reproducing a three-dimensional image corresponding to the three-dimensional object based on the elemental images and the at least one intermediate elemental image.

9. The method of claim 8, wherein the generating of the plurality of elemental images comprises:
extracting elemental images of different perspectives from the three-dimensional object; and
storing the extracted elemental images.

10. The method of claim 8, wherein the reproducing comprises:
displaying the elemental images and the intermediate elemental image; and
reproducing a three-dimensional image corresponding to the three-dimensional object by projecting and overlapping and immersing the displayed elemental images and intermediate elemental image.

11. The method of claim 8, wherein the reproducing comprises:
displaying the elemental images and the intermediate elemental image; and
reproducing a three-dimensional image corresponding to the three-dimensional object by reflecting and overlapping and immersing the displayed elemental images and intermediate elemental image.

12. The method of claim 8, wherein the generating of the intermediate elemental image comprises performing a linear combination of two adjacent elemental images so as to generate the intermediate elemental image.

13. The method of claim 8, wherein the generating of the intermediate elemental image comprises generating the at least one intermediate elemental image based on the following formula:
I_{P}(x,y)=(1−α)·I_{L}(x+αd(x,y),y)+α·I_{R}(x−(1−α)d(x,y),y) (1)
whereas I_{P} is a pixel of an intermediate elemental image, I_{L} is a pixel of a left image of the two adjacent elemental images, I_{R} is a pixel of a right image of the two adjacent elemental images, d is a spatial difference between I_{L} and I_{R}, and 0≦α≦1.

14. The method of claim 8, wherein, if the three-dimensional image enlarges the three-dimensional object by n times, the number of the at least one intermediate elemental image generated between the adjacent elemental images is n−1.

15. An apparatus for generating a three-dimensional image based on elemental images, the apparatus comprising:
means for generating a plurality of elemental images from a three-dimensional object, wherein the elemental images comprise different perspectives;
means for generating at least one intermediate elemental image, based on parallax information between the generated elemental images; and
means for reproducing a three-dimensional image corresponding to the three-dimensional object based on the elemental images and the at least one intermediate elemental image.
